(19) United States
(12) Patent Application Publication
(10) Pub. No.: US 2018/0284980 A1
(43) Pub. Date: Oct. 4, 2018

(54) INFORMATION-PROCESSING DEVICE AND CONTROL METHOD THEREFOR

(71) Applicant: CANON KABUSHIKI KAISHA, Tokyo (JP)

(72) Inventor: Takahiro Matsushita, Tokyo (JP)

(21) Appl. No.: 16/001,132

(22) Filed: Jun. 6, 2018

Related U.S. Application Data
(63) Continuation of application No. PCT/JP2016/087156, filed on Dec. 14, 2016.

(30) Foreign Application Priority Data
Dec. 22, 2015 (JP) 2015-249392
Oct. 5, 2016 (JP) 2016-197269

(51) Int. Cl. G06F 3/0484; G06F 3/0488

(52) U.S. Cl. CPC G06F 3/04847; G06F 3/04883

(57) ABSTRACT

A method of controlling an information-processing device includes: causing a display device to display a movable user interface element (UI element); detecting a user operation on the display device; acquiring a first position at which the user operation is detected on the display device; determining a second position at which the UI element is displayed on the display device, based on the acquired first position; storing the second position at the time of termination of detection of the user operation; calculating a distance between a third position when detection of a user operation is newly started and the stored second position, and controlling, when detection of the user operation is newly started, the UI element to be selectively displayed at any one of a fourth position determined based on the third position and the second position, in accordance with the calculated distance.

### CROSS-REFERENCE TO RELATED APPLICATIONS

This application is a Continuation of international Patent Application No. PCT/JP2016/087156, filed Dec. 14, 2016, which claims the benefit of Japanese Patent Application No. 2015-249392, filed Dec. 22, 2015 and Japanese Patent Application No. 2016-197269, filed Oct. 5, 2016, all of which are hereby incorporated by reference herein in their entirety.

### BACKGROUND OF THE INVENTION

### Field of the Invention

The present invention relates to an information-processing device having a user interface function which enables a position to be designated in response to a user operation, a control method for the information-processing device, and a program.

### Background Art

A seek bar is known as a user interface (UI) for designating a position. For example, a seek bar can be used to select a display image from a group of continuously photographed images. Other examples of such GUIs include a slider bar and a scroll bar.

PTL 1 discloses an imaging device which is capable of performing consecutive photography and which enables a user to select one image from a group of continuously-photographed images using a GUI of which a slide operation can be performed. In PTL 1, as the user performs a leftward or rightward drag operation of a knob along a slide bar using a finger, a photographed image having been photographed at a time corresponding to an amount of sliding is displayed in a display area.

In addition, mobile devices such as a smartphone and a tablet have a function which enables an adjustment value such as white balance to be changed based on a pixel at a touched position. For example, there is a method which involves having a user designate a pixel in an image using an operation control (an indicator such as a cursor) and changing white balance of a displayed image based on the designated pixel. In doing so, there is a need for a UI which enables a user to readily select a desired position in an image.

When the user operates a knob using a finger on a touch panel described in PTL 1, it is difficult to accurately designate a precise position. In particular, when an overall length of a slide bar is short, assigning a large number of photographed images means that every single image corresponds to an extremely narrow range in the slide bar. This makes it extremely difficult for the user to designate a position of a desired image by a touch operation and to redesignate a same image having been previously designated.

The problem described above is not limited to a seek bar and occurs when moving any user interface element and, particularly, a user interface element with a small display area. In addition, the problem described above not only occurs when input is performed by a touch operation but also occurs when input is performed using any pointing device (pointing input device).

In consideration of the circumstances described above, an object of the present invention is to improve usability of a user interface which enables a position to be designated in response to a user operation.

### CITATION LIST

### Patent Literature

PTL 1: Japanese Patent Application Laid-open No. 2014-183564

### SUMMARY OF INVENTION

An information-processing device according to an aspect of the present invention includes: display controlling unit configured to cause a display device to display a movable user interface element (UI element); detecting unit configured to detect a user operation on the display device; acquiring unit configured to acquire a first position at which the user operation is detected on the display device; determining unit configured to determine a second position at which the UI element is displayed on the display device, based on the acquired first position; storing unit configured to store the second position at the time of termination of detection of the user operation by the detecting unit; and calculating unit configured to calculate a distance between a third position when detection of a user operation is newly started and the second position stored in the storing unit, wherein when detection of the user operation is newly started, the display controlling unit controls the UI element to be selectively displayed at any one of a fourth position determined based on the third position and the second position stored in the storing unit, in accordance with the calculated distance.

An information-processing device according to an aspect of the present invention includes: detecting unit configured to detect a touch operation on a display device; processing unit configured to execute a process based on a position corresponding to the touch operation; storing unit configured to store the position used for the execution of the process; and calculating unit configured to calculate a distance based on a position corresponding to a touch operation on the display device, wherein the detecting unit detects a first touch operation and a second touch operation on the display device, the storing unit stores a first position corresponding to the first touch operation, the calculating unit calculates, when a second touch operation on the display device is detected, a distance between the stored first position and a second position corresponding to the second touch operation, the processing unit executes, in response to the first touch operation, a process based on the first position corresponding to the first touch operation, when the distance is shorter than a prescribed value, executes a process based on the first position in response to the second touch operation, and when the distance is longer than the prescribed value, executes a process based on the second position in response to the second touch operation.

A control method for an information-processing device according to an aspect of the present invention includes the steps of causing a display device to display a movable user interface element (UI element); detecting a user operation on the display device; acquiring a first position at which the user operation is detected on the display device; determining a second position at which the UI element is displayed on the display device, based on the acquired first position; storing the second position at the time of termination of detection of the user operation; calculating a distance between a third position when detection of a user operation is newly started and the stored second position; and controlling, when detection of the user operation is newly started, the UI element to be selectively displayed at any one of a fourth position determined based on the third position and the second position, in accordance with the calculated distance.

A control method for an information-processing device according to an aspect of the present invention includes the steps of: detecting a first touch operation on a display device; executing, in response to the first touch operation, a process based on a first position corresponding to the first touch operation; storing the first position used for the execution of the process; calculating, when a second touch operation on the display device is detected, a distance between the stored first position and a second position corresponding to the second touch operation; and executing a process based on the first position in response to the second touch operation when the distance is shorter than a prescribed value, but executing a process based on the second position in response to the second touch operation when the distance is longer than the prescribed value.

Further features of the present invention will become apparent from the following description of exemplary embodiments with reference to the attached drawings.

### BRIEF DESCRIPTION OF DRAWINGS

FIG. 1 is a block diagram showing a configuration of an information-processing device according to an embodiment;

FIG. 2 is a block diagram showing functions of an information-processing device according to an embodiment;

FIGS. 3A to 3C are diagrams showing an example of a seek bar UI according to an embodiment;

FIG. 4 is a flow chart showing a control method for a seek bar UI according to a first embodiment;

FIGS. 5A to 5F are diagrams explaining an operation example of a seek bar UI according to the first embodiment;

FIG. 6 is a flow chart showing a control method for a seek bar UI according to a second embodiment;

FIG. 7 is a flow chart showing a control method for a seek bar UI according to a third embodiment;

FIGS. 8A and 8B are diagrams showing an example of a seek bar UI according to a fourth embodiment;

FIG. 9 is a flow chart showing a control method for a seek bar UI according to the fourth embodiment;

FIG. 10 is a diagram showing an example of a threshold setting UI according to a sixth embodiment;

FIG. 11 is a flow chart showing a control method for an operation control according to a seventh embodiment;

FIG. 12 is a diagram showing an example of a display screen of a mobile device 100 according to the seventh embodiment;

FIGS. 13A to 13F are diagrams showing an example of a control method for an operation control according to the seventh embodiment;

FIG. 14 is a flow chart showing a control method for an operation control according to an eighth embodiment;

FIG. 15 is a flow chart showing a control method for an operation control according to a ninth embodiment;

FIGS. 16A and 16B are diagrams showing an example of a control method for an operation control according to the ninth embodiment;

FIG. 17 is a flow chart showing a control method for an operation control according to a tenth embodiment; and

FIG. 18 is a diagram showing an example of a setting UI for respective settings according to an eleventh embodiment.

### DESCRIPTION OF EMBODIMENTS

Hereinafter, embodiments of the present invention will be described in detail with reference to the drawings. It is to be understood that the embodiments described below merely represent examples of means of realizing the present invention and may be appropriately corrected or modified according to a configuration of a device to which the present invention is applied and according to various conditions, and that the present invention is not limited to the following embodiments.

In addition, the present invention can also be realized by supplying a system or a device with a storage medium on which is recorded a program code and having a computer (or a CPU or an MPU) of the system or the device read and execute the program code stored in the storage medium. In this case, the program code itself having been read from the storage medium is to realize the functions of the embodiments described above, and the program code itself and the storage medium storing the program code in a non-transitory manner are to constitute the present invention. Examples of storage media which can he used to supply the program code include a flexible disk, a hard disk, an optical disk, a magneto-optical disk, CD-ROM, a CD-R, a magnetic tape, a nonvolatile memory card, and a ROM.

In addition, it is needless to say that the present invention also includes aspects in which, based on instructions of a program code read from a storage medium, an OS or the like running on a computer performs a part of or all of the actual processes and the functions of the embodiments described earlier are realized by the processes.

Furthermore, a program code read from a storage medium may be written into a memory provided in a function expansion board inserted into a computer or a function expansion unit connected to the computer. It is needless to say that the present invention also includes aspects in which, subsequently, a CPU or the like provided in the function expansion board or the function expansion unit performs a part or all of the actual processes based on instructions of the program code and the functions of the embodiments described earlier are realized by the processes.

Hereinafter, a touch panel will be mainly used as an example of a pointing device. The pointing device is an input device which enables input of a point start, a drag, a point termination, and the like to be performed. Examples of a pointing device include a touch panel, a touch pad, a mouse, a pointing stick, a track ball, a joystick, and a pen tablet. When a touch panel s used, a point operation is called a touch operation. In addition, hereinafter, a start of a point operation and a termination of a point operation will be respectively referred to as a touch-on and a touch-off.

<Device Configuration>

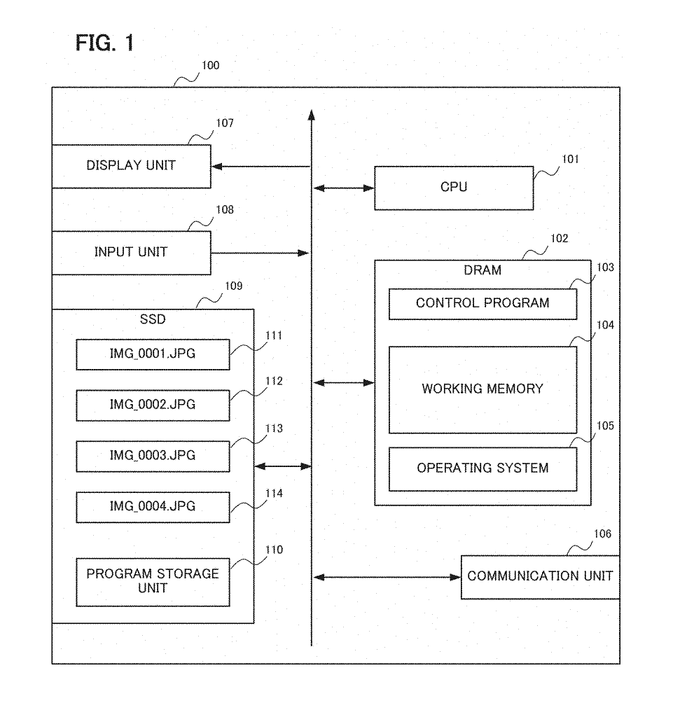

FIG. 1 is an internal configuration diagram of a mobile device 100 according to an embodiment of the present invention which is a smartphone or a tablet. The mobile device 100 is constituted by a CPU 101, a DRAM 102, a communication unit 106, a display unit 107, an input unit 108, and an SSD 109.

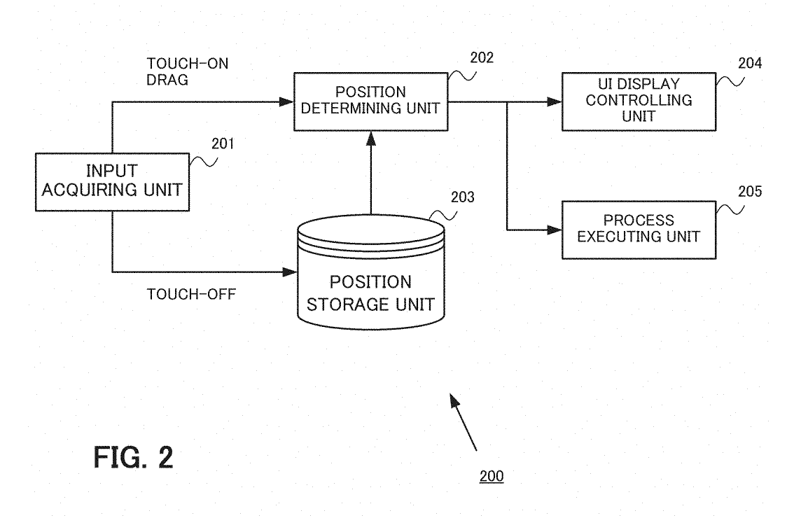

The CPU (Central Processing Unit) 101 performs various calculations and controls various portions constituting the mobile device 100 in accordance with input signals and programs. The CPU 101 provides a seek bar UI control function 200 such as that shown in FIG. 2 by executing a control program 103 loaded to the DRAM 102. In other words, the CPU 101 functions as an input acquiring unit 201, a position determining unit 202, a position storage unit 203, a UI display controlling unit 204, and a process executing unit 205. The input acquiring unit 201 acquires an input from the input unit 108 The position determining unit 202 determines a knob position of a seek bar UI. The position storage unit 203 stores a reference position of a knob. The UI display controlling unit 204 outputs, to the display unit 107, data for causing the display unit 107 to display the seek bar UI. The process executing unit 205 executes prescribed processes such as changing a display image in accordance with an input to the seek bar UI by a user. Details of these functional units will be provided later.

The DRAM (Dynamic Random Access Memory) 102 is a primary storage device. The DRAM 102 stores the control program 103 and an operating system 105 read from a program storage unit 110. The control program 103 includes a program used by the mobile device 100 to manage images. The operating system 105 includes a program used by the mobile device to perform basic operations. A part of the DRAM 102 is used as a working memory 104 when the CPU 101 executes each program.

The SSD (Solid State Drive) 109 is a secondary (auxiliary) storage device which uses a nonvolatile flash memory. With devices such as mobile devices which are carried around in many use cases, SSDs with low power consumption and high impact resistance are generally used instead of HDDs (Hard Disk Drives) which have been conventionally commonly used in PCs.

The program storage unit 110 stores programs used by the present mobile device 100 to execute various functions and a basic operating system program. The programs are loaded to the DRAM 102 which enables read and write at higher speeds as a primary memory and are sequentially load to and executed by the CPU 101. Operations which result from the SSD 109, the DRAM 102, and the CPU 101 executing these programs for executing functions as a mobile device are similar to operations of mobile devices generally used today.

The SSD 109 stores a plurality of pieces of image data 111, 112, 113, and 114. These pieces of image data are JPEG files photographed by an imaging device. FIG. 1 shows that four image files, IMG_0001.JPG to IMG_0004.JPG, have already been transferred among 100 image files, IMG_0001.JPG to IMG_0100.JPG, in the imaging device. Similar descriptions apply to moving images, continuously photographed images, and audio.

The display unit 107 is an image display device such as a liquid crystal display. While the display unit 107 is generally integrally provided with a main body in a mobile device, alternatively, a display device which differs from a mobile device main body may be connected to the mobile device. The display unit 107 displays various information including image data and a control (also referred to as a UI element or a UI object) for user operations. The input unit 108 is a component used by the user to perform input with respect to the mobile device 100. In the present embodiment, it is assumed that the input unit 108 is constituted by a touch panel which is generally used in mobile devices. The touch panel detects a touch operation by the user on the image display device. A system of the touch panel is not particularly limited and any of existing systems such as a capacitance system, a resistive film system, and a surface acoustic wave system can be adopted.

The communication unit 106 performs transmission/reception of data to/from other devices by wireless communication or wired communication. For example, the communication unit 106 provides communication via a wireless connection such as a wireless LAN or communication via a wired connection such as a USB (Universal Serial Bus) cable. The communication unit 106 may be directly connected to an external device or connected to an external device via a server or a network such as the Internet.

<Seek Bar UI>

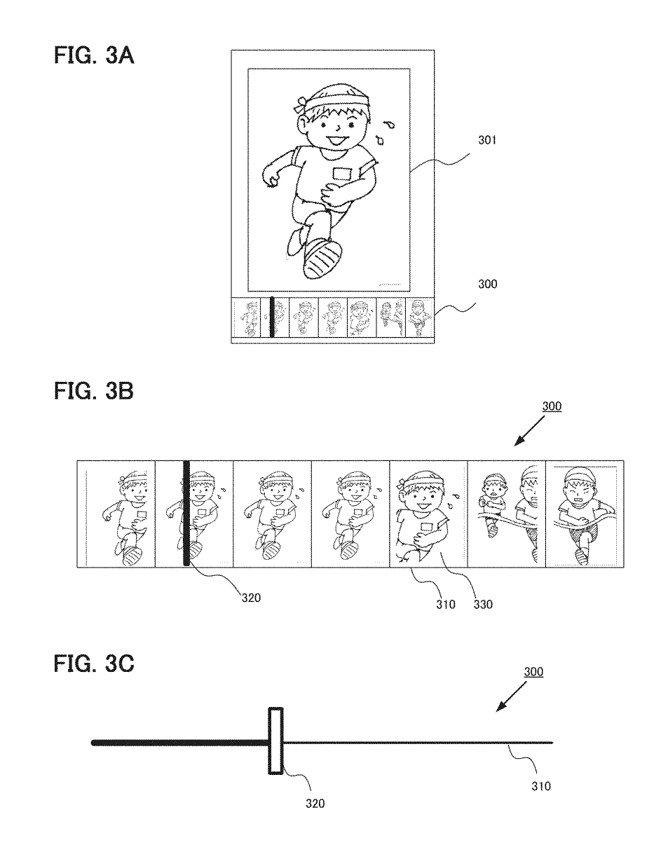

A seek bar user interface used in the present embodiment will be described with reference to FIGS. 3A to 3C. Here, using an example of a plurality of still images having been continuously photographed as content, an example of a use case in which a seek bar UI is used in order to switch between still images to be displayed among the plurality of still images will be described. FIG. 3A shows an example of a display screen which includes an image display area 301 and a seek bar UI 300.

FIG. 3B is a diagram showing a detailed configuration of the seek bar UI 300. The seek bar UI 300 is provided with a track 310 which is a horizontally-long rectangular operating region and a knob 320 which is movable leftward and rightward along the track 310. It should be noted that a “knob” may also be referred to as a “thumb”, an “indicator”, a “tab”, or the like. The knob currently indicates a position of an image being displayed among all of the plurality of continuously photographed images and, by moving the knob 320, the user can switch between images displayed in the image display area 301. In the image display area 301, an image corresponding to a position of the knob 320 is displayed. For example, in a case where there are 140 continuously-photographed images, a first image is displayed when the knob 320 is at a left end of the track 310, a 140th image is displayed when the knob 320 is at a right end of the track 310, and a 24th image is displayed when the knob 320 is at a position expressed as 24/140 from the left end.

Thumbnails 330 of a part of the continuously-photographed images are displayed on the track 310 of the seek bar UI 300 in order to show contents of the continuously-photographed images in an easily understood manner. In the example shown in FIG. 3B, seven thumbnails are displayed in a row, in which the respective thumbnails represent images at positions of 0/6, ⅙, . . . , 6/6 among the continuously-photographed images. The knob 320 of the seek bar UI 300 moves along the row of the thumbnails 330.

A basic method of moving the knob 320 is as follows. Moreover, basic operations of the seek bar UI will now be described and details of the operations of the seek bar UI according to the present embodiment will be provided later. When the user touches on (starts pointing) any position on the track 310, the knob 320 moves to the position. When the user drags the knob 320, the knob 320 moves accordingly. More specifically, first, the knob 320 moves to a start position of a drag (a touch-on position), and the knob 320 subsequently moves in accordance with a movement amount of the drag.

In addition, the position of the knob 320 can also be moved by switching between images to be displayed in the image display area 301. For example, when the user performs a swipe operation in the image display area 301, an image displayed in the image display area 301 is switched and, accordingly, the knob 320 moves to a position corresponding to the image after switching.

Moreover, a specific display mode of the seek bar UI 300 is not limited to that shown in FIG. 3B. The seek bar UI need only enable the knob 320 to move along the track 310 and, for example, thumbnails need not be displayed on the track 310. FIG. 3C shows another example of the seek bar UI 300.

Inside the computer, the seek bar 300 is managed as a seek bar UI object. A seek bar UI object includes an internal state (a variable) such as a position of the knob 320 and a process (a function) upon occurrence of various events. Operations inside the computer when the user performs an operation on the seek bar UI on the display unit 107 will now be briefly described. An input from the input unit 108 is passed as an event to the OS, and the event is passed from the OS to the seek bar UI object. An internal state of the seek bar UI is changed in accordance with the event, and a predefined operation is performed in accordance with the change. More specifically, an internal variable representing a position of the knob 320 is updated in accordance with an event such as a touch-on or a drag input on the track 310 and, in accordance with the update, an update process of a display position of the knob 320 and a switching process of images displayed in the image display area 301 are performed.

With such a seek bar UI, it is difficult for the user to accurately touch the position of the knob 320 particularly when there are a large number of continuously-photographed images that are display objects. This makes it extremely difficult for the user to redesignate a same image which has been previously designated by the user.

### First Embodiment

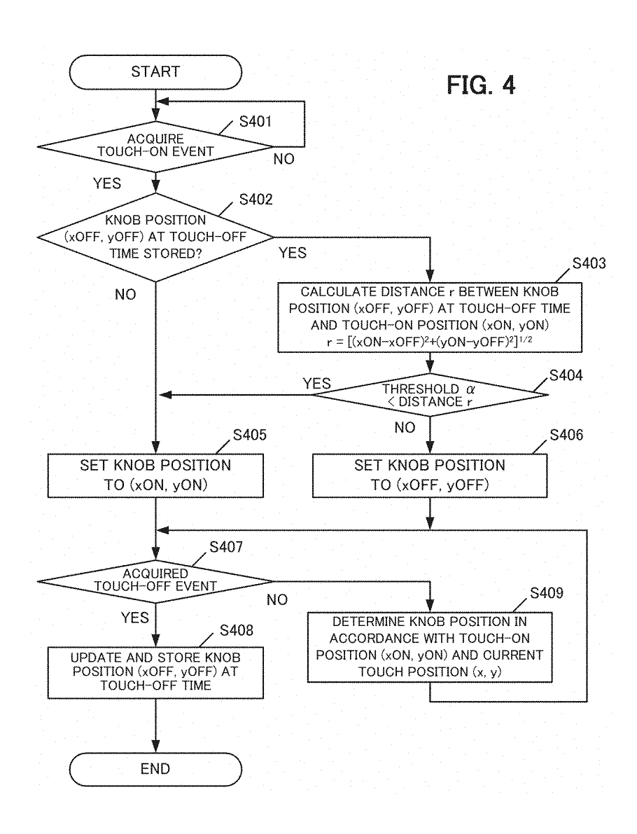

A control method for a seek bar UI according to an embodiment of the present invention will now be described with reference to FIGS. 2 to 4. In the control shown in FIG. 4, a position of the knob is determined based on a distance between a knob position at the time of a most recent touch-off (termination of pointing) in the seek bar and a position (a touch-on position, a point start position) at which a touch-on event has been acquired at the time of a touch-on (start of pointing). Note that, in the following description, a position of the knob in the seek bar UI is also referred to as a seek bar position for the sake of brevity.

In step S401, a determination is made regarding whether or not the input acquiring unit 201 has acquired a touch-on event in the seek bar UI 300. When a touch-on event in the seek bar UI 300 is not acquired (S401—NO), the process waits for acquisition of a touch-on event. When a touch-on event is acquired (S401—YES), the process advances to step S402.

In step S402, the position determining unit 202 determines whether or not a knob position (xOFF, yOFF) at the time of a touch-off in the seek bar is stored in the position storage unit 203. When a knob position at the time of a touch-off is not stored (S402—NO), the process advances to step S405. In step S405, the position determining unit 202 sets the knob position to a touch-on position (xON, yON).

On the other hand, when the position storage unit 203 stores a knob position at the time of a touch-off (S402—YES), the process advances to step S403. In step S403, the position determining unit 202 calculates a distance r between the knob position (xOFF, yOFF) at the time of the touch-off and the touch-on position (xON, yON) in the seek bar UI 300. The distance r can be calculated by r=[(xON−xOFF)²+(yON−yOFF)²]^{1/2}. Note that while (xON, yON) represents a touch position at the time of a touch-on, (xOFF, yOFF) represents a knob position instead of a touch position at the time of a touch-off.

In step S404, the position determining unit 202 determines whether or not the distance r is longer than a prescribed threshold α (distance r>threshold α). When the distance r is longer than the threshold α (distance r>threshold α), the process advances to step S405 and the position determining unit 202 sets the knob position to the touch-on position (xON, yON). On the other hand, when the distance r is equal to or shorter than the threshold α (distance r≤threshold α), the process advances to step S406 and the position determining unit 202 sets the knob position to the stored knob position (xOFF, yOFF) at the time of the touch-off.

In step S403, the distance r may be obtained as a distance along a movement direction of the knob. In the present example, since the knob moves in an x direction, distance r=|xON−xOFF| may be used. Alternatively, a knob position stored in the position storage unit 203 may be adopted as a knob drawing region. In this case, the distance between the touch-on position and the knob position may be set to zero if the touch-on position is inside the knob drawing region and set to a shortest distance between the touch-on position and the knob drawing region if the touch-on position is outside the knob drawing.

A magnitude of the threshold α may be a value set in advance or a value that is dynamically determined in accordance with a width of the knob 320 (when the width of the knob 320 is variable). For example, the threshold α can be set to approximately the same magnitude as (for example, around 1 to 1.5 times) a contact region between a finger and the touch panel when the user performs a touch operation. Alternatively, the threshold α can be set to around 1 to 10 times half the width of the knob 320. Alternatively, as the threshold α, a value selected based on a prescribed criterion from a plurality of values obtained as described above such as a minimum value or a maximum value among the plurality of values can be adopted.

In step S407, a determination is made regarding whether or not the input acquiring unit 201 has acquired a touch-off event. A touch-off event not having been acquired means that an operation such as a drag is ongoing and the linger is not vet separated from the touch panel. When a drag operation is being performed, the position determining unit 202 determines a knob position in accordance with a touch-on position (xON, yON) and a current touch position (x, y) (S409). For example, the position determining unit 202 determines a position obtained by adding a movement amount (x−xON, y−yON) or an x-direction movement amount (x−xON, 0) to the knob position determined in step S405 or S406 as a new knob position.

When a touch-off event has been acquired in step S407, the process advances to step S408 and a knob position at the time of acquisition of the touch-off event is stored in the position storage unit 203. When a knob position (xOFF, yOFF) is already stored in the position storage unit 203, the knob position is overwritten and updated by a new value.

Moreover, when hardly any time has elapsed from the time of a previous touch-off and a vicinity of a knob position at the time of the previous touch-off is touched on, it is highly likely that the user desires to designate the same knob position. On the other hand, when a long period of time has elapsed from the time of the previous touch-off, the likelihood of the user desiring to designate the same knob position has conceivably decreased even if a vicinity of a knob position at the time of the previous touch-off is touched on. In consideration thereof, in step S408, the time of acquisition of the touch-off event is stored in the position storage unit 203, in association with a knob position. In addition, in step S402, when a current time point represents a lapse of a prescribed period of time or more from the time stored in association with a knob position, a determination that a knob position at the time of a touch-off is not stored (No in S402) may be made. Alternatively, when a prescribed period of time elapses from the time stored in association with a knob position, the time may be erased together with the knob position from the position storage unit 203. With these configurations, since the knob position at the time of the previous touch-off is selectively used in accordance with not only a distance from the knob position at the time of the previous touch-off but also an elapsed time from the time of the previous touch-off, an accurate knob position that is more in tune with the user's intention can be designated.

Although not clearly indicated in the flow chart described above, with an update of the knob position, the UI display controlling unit 204 updates the display of the seek bar UI 300 and, at the same time, the process executing unit 205 performs prescribed processes. An example of the processes performed by the process executing unit 205 is a process of updating an image to be displayed in the image display area 301. These processes are executed when the knob position is updated in steps S405, S406, and S409.

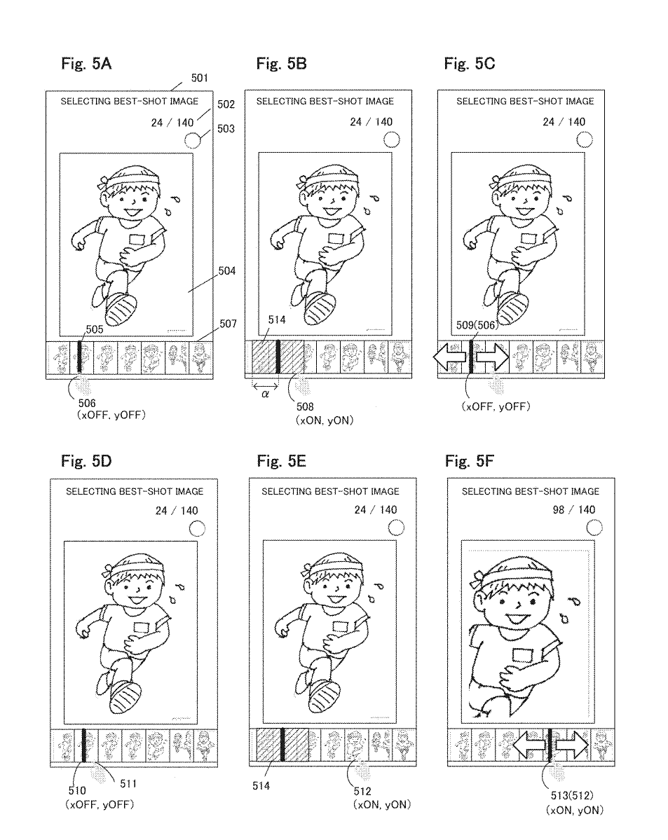

FIGS. 5A to 5F represent an example of a screen display including a seek bar UI in the example of a seek bar UI control method described above. Hereinafter, an operation example of the seek bar UI control method described above will be described with reference to FIGS. 5A to 5F.

FIG. 5A shows a user interface 501 that is displayed on the display unit 107 when the mobile device 100 executes a program for selecting a best shot image from continuously photographed images. In this case, a description will be given based on the premise that 140 images are photographed as continuously photographed images and are stored in the SSD 109. However, continuously photographed images taken by a camera (not shown) or continuously photographed images stored by another external device may be transferred to the mobile device 100 and displayed on the mobile device 100. A specific format of a plurality of continuously photographed images is arbitrary, and the plurality of continuously photographed images may be stored in one file or each of the continuously photographed images may be stored in different files.

A left-side numerical value of a display 502 indicates an image number of an image currently being displayed. An image number indicates an order at which an image had been photographed from a first image of the continuously photographed images. A right-side numerical value of the display 502 indicates a total number of the continuously photographed images. A check box 503 is used by the user to select (designate) a best shot among the continuously photographed images. The user turns on the check box 503 when selecting a currently displayed image as a best shot. A configuration may be adopted in which the check box 503 is checked when the user touches on a preview image 504. By performing a prescribed operation when nothing is done) after checking the check box 503, an image corresponding to the checked preview image is saved or marked as a best shot image.

The preview image 504 is an enlarged display of an image corresponding to a seek bar position (a knob position in the seek bar UI) among the continuously photographed images. The seek bar UI is constituted by a track 507 and a knob 505 that is movable along the track 507. The knob 505 moves, leftward or rightward, on the track 507 on which thumbnails are arranged by an operation such as a touch-on and a drag. Thumbnail images of the continuously photographed images are displayed on the track 507 of the seek bar UI. If feasible (if the total number of continuously photographed images is small), all thumbnail images of the continuously photographed images are displayed superimposed on the track 507. However, when all thumbnail images of the continuously photographed images cannot be displayed (including cases where thumbnail images become smaller than a prescribed criterion), thumbnail images of a part of the continuously photographed images are displayed superimposed on the track 507.

In FIG. 5A, a position 506 (xOFF, yOFF) is a knob position at the time of a touch-off by the user from the seek bar UI. The position 506 is stored in the position storage unit 203. FIG. 5B shows a position 508 (xON, yON) at which the user once again touches on the seek bar UI after the touch-off shown in FIG. 5A. When a touch-on event is acquired on the seek bar UI, a distance r between the knob position 506 at the time of the previous touch-off and the touch-on position 508 is calculated. A region 514 indicated by hatchings in FIG. 5B represents a region at a distance within the threshold α from the knob position 506 at the time of the touch-off. It should be noted that, although the region 514 is drawn on the drawings for explanatory purposes, in reality, the region 514 is not displayed on the screen in the present embodiment. Needless to say, the region 514 may be explicitly displayed on the screen.

In the present example, the distance r between the touch-on position 508 and the knob position 506 at the time of the touch-off is equal to or shorter than the threshold α. Accordingly, as shown in FIG. 5C, the position determining unit 202 sets a knob position 509 at the time of acquisition of a touch-on event to a same position as the knob position 506 at the time of the previous touch-off, and enables movement of the knob with the position 506 as a start position. In other words, when the touch-on position (xON, yON) is close to a knob position (xOFF, yOFF) at the time of a touch-off prior to the touch-on, the knob position is unchanged. In addition, as the user subsequently performs a drag operation after the touch-on, the knob moves from the position 506 by an amount in accordance with a drag amount.

In FIG. 5D, a position 510 is a knob position at a point where the user touches off once again from the seek bar UI. As described earlier, a touch-off position 511 differs from the knob position 510. The knob position stored in the position storage unit 203 is updated from the position 506 to the position 510. FIG. 5E shows a position 512 at which the user once again touches on the seek bar UI after the touch-off shown in FIG. 5D. In a similar manner to that described earlier, a distance r between the knob position 510 at the time of the previous touch-off and the touch-on position 512 is calculated. In this case, the distance r is longer than the threshold α. Accordingly, as shown in FIG. 5E, the position determining unit 202 sets the position 512 at the time of acquisition of a touch-on event as the knob position 513, and enables movement of the knob with the position 513 as a start position. In other words, when the touch-on position is distant from a knob position at the time of a touch-off prior to the touch-on, the knob position is changed to the touch-on position. In addition, as the user subsequently performs a drag operation after the touch-on, the knob moves from the touch-on position 512 (513) by an amount in accordance with a drag amount.

Moreover, the present embodiment as described above may be selectively performed depending on conditions. For example, the present embodiment described above is performed when conditions are satisfied such as the present embodiment being configured to be performed in advance by the user, operating under a specific mode, and a specific UI element being operated. When the conditions are not satisfied, the knob position is determined in accordance with a new touch-on position even if a distance between the knob position at the time of the previous touch-off and the new touch-on position is shorter than the threshold.

According to the present embodiment, when designating a position on the seek bar UI by a touch-on operation of the user, a seek bar (knob) position is determined in accordance with a distance between a previous touch-off position and a current touch-on position. Specifically, a knob position at the time of the previous touch-off is once again determined as the knob position when the distance is short but the current touch-on position is determined as the knob position when the distance is long. Therefore, when the user desires to once again designate a same position after touching off and touches on a vicinity of a knob position at the time of the previous touch-off, the knob position at the time of the previous touch-off is designated. Since the user need not accurately touch on the knob position at the time of the previous touch-off, the user can readily redesignate the same knob position as before. On the other hand, when the user touches on a position at a distance from the knob position at the time of the previous touch-off, since it is highly likely that the user desires to designate a brand new position, the knob position is moved to a position corresponding to the current touch-on position. As a result, the user can readily designate an accurate knob position that is in tune with the user's intention without having to perform special operations.

### Second Embodiment

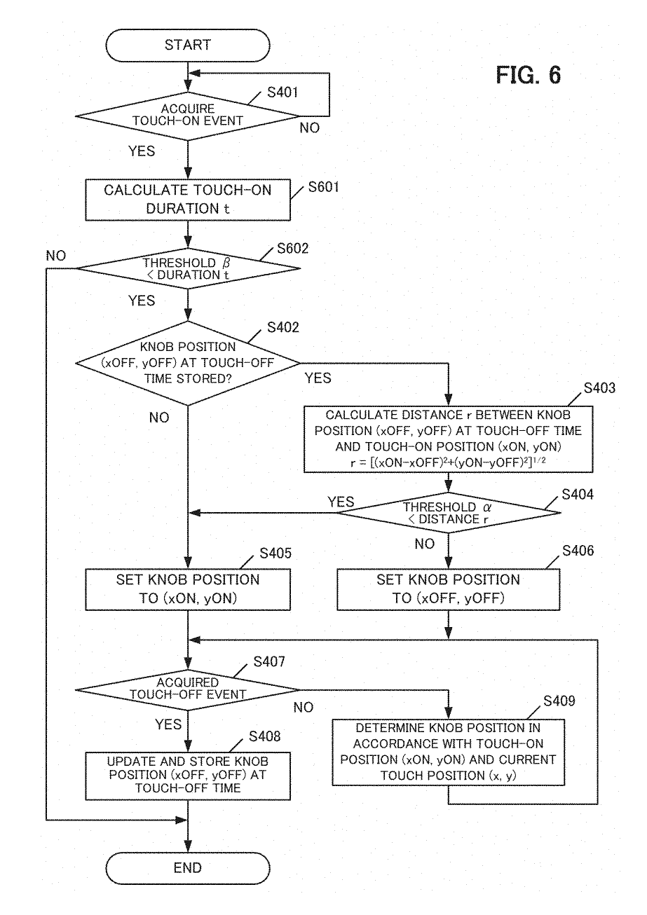

A control method for a seek bar UI according to an embodiment of the present invention will now be described with reference to FIG. 6. While control in the present embodiment is basically similar to that of the embodiment described above, a function for preventing a movement of the seek bar due to an erroneous operation by the user has been added. Hereinafter, a difference from the first embodiment will be mainly described.

In the present embodiment, in order to prevent erroneous operations, a movement of the seek bar (knob) is started after a prescribed period of time has lapsed after detection of a touch-on event. To this end, a process of steps S601 and S602 has been added to the processes (FIG. 4) of the first embodiment.

In step S601 after detection of a touch-on event, the position determining unit 202 calculates a touch-on duration t. In step S602, the position determining unit 202 determines whether or not the touch-on duration t is longer than a threshold time β. When the touch-on duration t is longer than the threshold β, processes of step S402 and thereafter are executed in a similar manner to the first embodiment. When the touch-on duration t is equal to or shorter than the threshold β, the process is terminated.

The touch-on duration t is a period of time in which, after a touch-on event is detected, a touch position is continuously being touched by a prescribed amount or more without moving therefrom. The flow chart is drawn such that the touch-on duration t is first obtained and subsequently compared with the threshold time β for the sake of brevity. However, a configuration may be adopted in which processes of step S402 and thereafter are executed once a period of time in which a substantially same position is continuously touched exceeds the threshold time β but the process is terminated if a touch-off or a drag of a prescribed amount or more occurs before the lapse of the threshold time β.

According to the present embodiment, a touch input equal to or shorter than the threshold time β can be disabled and processes can be enabled when a touch input equal to or longer than the threshold time β (a so-called long tap) is performed. In other words, an effect is produced which prevents the seek bar from moving when the user touches the screen by mistake.

Moreover, while a start of processes is determined solely based on a duration of a touch-on in the description given above, other elements may also be taken into consideration. For example, input may be disabled when a touch position moves by a threshold distance or more after touch-on and before the threshold time β lapses.

In addition, the “touch-on position” in steps S402 and thereafter in the present embodiment may be set to a touch position upon an occurrence of a touch-on event or a touch position at a time point after a lapse of the threshold time β from an occurrence of a touch-on.

### Third Embodiment

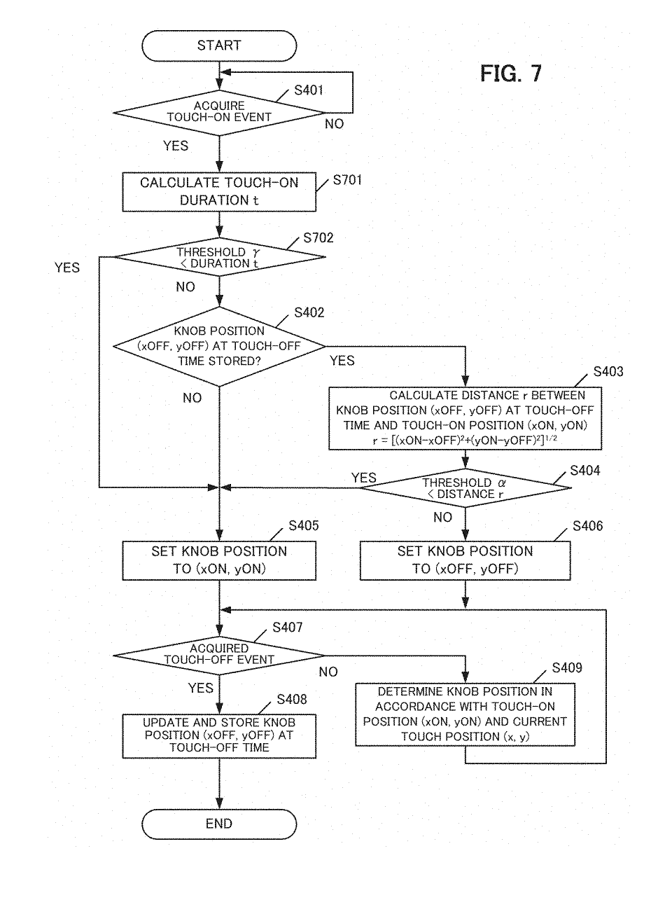

A control method for a seek bar UI according to an embodiment of the present invention will now be described with reference to FIG. 7. In the present embodiment, when the user performs a long tap, a determination is made that the user intends to move the knob of the seek bar to a touch position and a knob position at the time of a touch-off is not compared with a touch-on position.

The calculation process of the touch-on duration t in step S701 is similar to step S601 in the second embodiment. In step S702, the touch-on duration t is compared with a threshold γ, and when the touch-on duration t is equal to or shorter than the threshold time γ (S702—NO) or, in other words, when a long tap is not being performed, the process advances to step S402 and processes similar to the first embodiment are performed. On the other hand, when the touch-on duration t is longer than the threshold time (S702—YES) or, in other words, when a long tap is performed, the process advances to step S405 and sets the knob position to a touch-on position.

The threshold time γ may or may not be the same as the threshold time β according to the second embodiment. When combining the second and third embodiments, γ is set larger than β (β<γ).

According to the present embodiment, when the user intentionally performs a long tap operation, the knob position can be moved to a position where a knob position had been touched on regardless of a distance between the knob position at the time of a touch-off and a touch-on position.

Moreover, a process described below may be performed instead of the process described above. When a touch-on event is acquired, the processes of steps S402 and thereafter are immediately performed to change a knob position. In addition, when a long tap event is subsequently detected, the knob is moved to a long tap position (a touch-on position). Performing this process produces a similar effect.

### Fourth Embodiment

In the first to third embodiments, switching is performed between processes in accordance with a distance between a knob position at the time of a touch-off and a touch-on position. However, a position of the knob of the seek bar UI changes due to factors other than a touch operation on the seek bar. For example, when a moving image or an audio file is being played back, the knob position is switched to another in accordance with a playback location. In the present embodiment, the seek bar UI is used for playback and editing of moving image files.

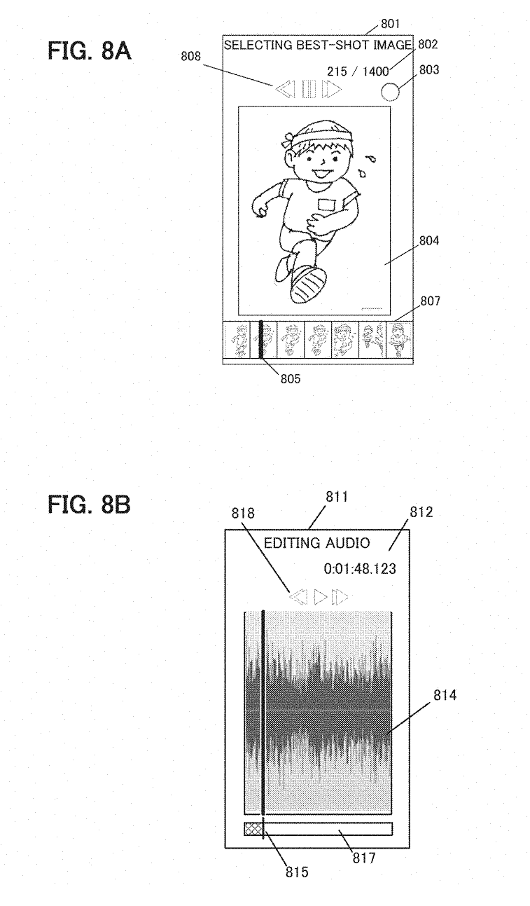

FIG. 8A shows a user interface 801 that is displayed on the display unit 107 when the mobile device 100 executes a program for selecting a best shot image from images constituting a moving image. A display 802 represents the total number of frames constituting a moving image and a current frame position. A check button 803 is used to select a best shot image. A preview image 804 displays a currently designated frame image. A seek bar UI at the bottom of the screen is constituted by a knob 805 and a track 807 displaying a prescribed number of (in this case, seven) thumbnail images of the moving image in a row. An audio control 808 is used to perform operations with respect to a moving image such as playback, pause, frame-by-frame playback, and frame-by-frame rewind. Displays of playback and pause are alternately switched therebetween.

FIG. 8B shows a user interface 811 that is displayed on the display unit 107 when the mobile device 100 executes a program for editing an audio file. A basic configuration of the user interface 811 is similar to that of the user interface 801 shown in FIG. 8A. A difference is that an audio waveform 814 of a current position is displayed at center of the screen and that thumbnails and the like are not displayed on a track 817.

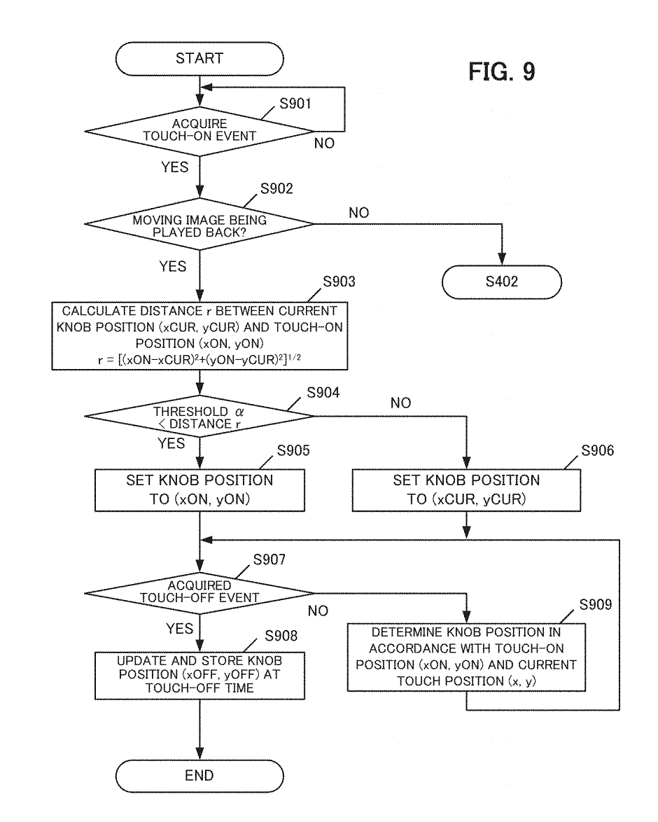

Since a basic configuration of the present embodiment is similar to that of the first embodiment, processes will not be repeated. FIG. 9 is a flow chart showing a control method for a seek bar UI according to the present embodiment.

A control method for a seek bar UI according to the present embodiment will be described with reference to FIG. 9. In step S901, a determination is made regarding whether or not the input acquiring unit 201 has acquired a touch-on event in the seek bar UI. When a touch-on event in the seek bar UI is not acquired (S901—NO), the process waits for acquisition of a touch-on event. When a touch-on event is acquired (S401—YES), the process advances to step S902.

In step S902, a determination is made regarding whether or not a moving image is being played back. When a moving image is not being played back (S902—NO), processes similar to those of steps S402 and thereafter of the first embodiment (FIG. 4) are executed. On the other hand, when a moving image is being played back (S902—YES), the process advances to step S903.

Steps S903 to S909 are basically similar to the processes of steps S403 to S409 in the first embodiment (FIG. 4). A difference is that a current knob position (xCUR, yCUR) is used in place of a knob position (xOFF, yOFF) at the time of a touch-off. Therefore, contents of processes of steps S903 and S906 differ.

Alternatively, in the present embodiment, processes of steps S903 and thereafter may be performed regardless of whether a moving image is being played back or whether playback is paused. Accordingly, by touching a vicinity of a current knob position, a movement can be started from the current knob position. Furthermore, the present embodiment can be applied when displaying continuously-photographed images as in the first to third embodiments in addition to playing back and editing moving images, audio, and the like.

### Fifth Embodiment

In the first to fourth embodiments, switching is performed between processes in accordance with a distance between a touch-on position and a single reference position (a knob position at the time of an immediately-previous touch-off or a current knob position). In the present embodiment, a knob position is determined based on a comparison with a plurality of reference positions. Therefore, a plurality of reference positions are stored in the position storage unit 203. The plurality of reference positions include knob positions at the times of a plurality of touch-off operations (times of point terminating operations) in previous seek bar UIs and a current knob position. In addition, more specifically, the knob position at the time of a previous touch-off operation can be set to a knob position at the time of an immediately-previous touch-off or a knob position at the time of a touch-off within a prescribed immediately-previous period of time. Furthermore, the position determining unit 202 calculates distances between the touch-on position and all of the reference positions, and when the distance from any of the reference positions is equal to or shorter than a threshold, the position determining unit 202 assumes that the reference position has been touched. When the distances from two or more reference positions are equal to or shorter than the threshold, it may be assumed that the reference position nearest to the touch-on position has been touched.

In addition, conditions described below may be further added when adopting a reference position as a knob position. For example, when the knob position after a touch-off satisfies a condition that the knob position remains stationary at the position for a prescribed period of time or more because, for example, switching of display of content such as images has not been performed, the knob position is stored as a reference position. This is because content such as an image that is displayed in association with a position that remains fixed for a certain amount of time is conceivably important, but content corresponding to a knob position that is changed in a short while is conceivably unimportant. In addition, when the user performs a prescribed operation after a touch-off, a knob position at the time of the touch-off may be set and stored as a reference position. The prescribed operation is, for example, an operation by which the user explicitly or implicitly instructs the knob position at the time of the touch-off to be stored as a reference position.

### Sixth Embodiment

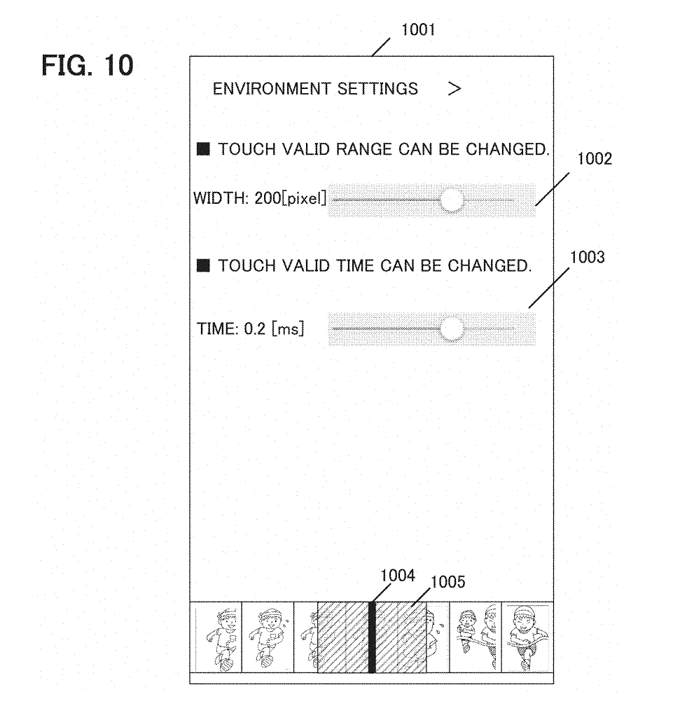

The threshold distance α in the first to fifth embodiments and the thresholds β and γ with respect to a touch-on duration in the second and third embodiments can be made settable by the user. FIG. 10 shows an example of a user interface for setting the thresholds α and β. Note that the user interface refers to the distance threshold α as a “touch valid range” and the time threshold β as a “touch valid time”.

An environment setting UI 1001 includes a slider control 1002 for changing a touch valid range. In the environment setting UI 1001, a touch valid range 1005 is displayed on both sides of a knob 1004 of a seek bar. When the user changes a value by operating the slider control 1002, the touch valid range 1005 on both sides of the knob 1004 is displayed so as to expand and contract leftward and rightward in accordance with the change. In addition, the environment setting UI 1001 includes a slider control 1003 for changing a touch valid time. The touch valid time is used as the threshold β which prevents the seek bar from moving when being erroneously touched by the user. Although not described herein, a control for setting a valid time (a threshold γ) for moving a position of the seek bar when a long press is performed may be separately provided. In addition, whether or not to execute control using the touch valid range or the touch valid time described above may be made settable.

While an example in which a valid range or a valid time is designated using slider controls has been described above, alternatively, these values may be input as numerical values or input using a spin control or the like. Alternatively, a touch valid range may be designated in a display region of the seek bar UI at the bottom of the screen.

### Seventh Embodiment

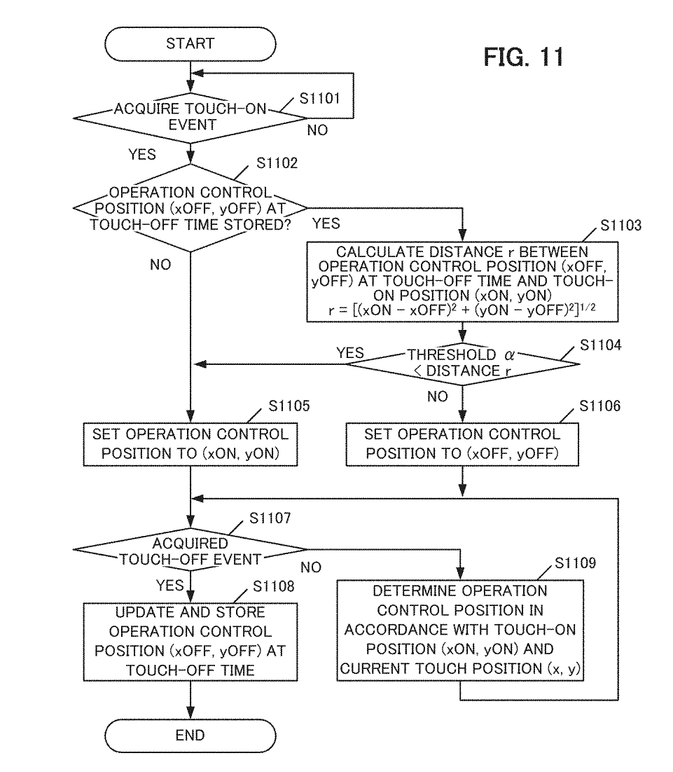

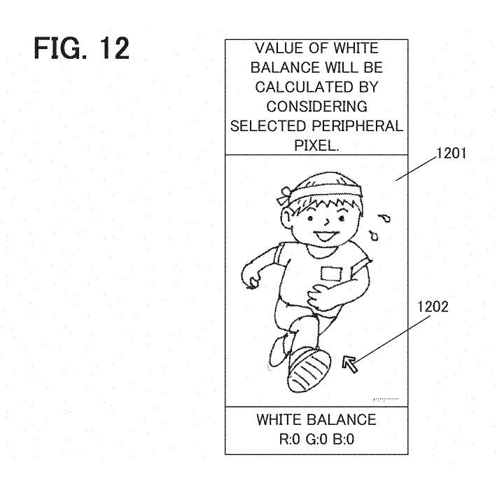

A control method for an operation control according to an embodiment of the present invention will now be described with reference to FIGS. 2, 11, and 12. The operation control refers to an arrow cursor or the like displayed on an image display area 1201 of a display device such as that indicated by reference numeral 1202 in FIG. 12. In the control shown in FIG. 11, a position of the operation control is determined based on a distance between an operation control position at the time of a most recent touch-off on an operation screen and a position (a touch-on position, a point start position) at which a ouch-on event at the time of a touch-on has been acquired. Hereinafter, respective steps of FIG. 11 will be described in detail.

In step S1101, a determination is made regarding whether or not the input acquiring unit 201 has acquired a touch-on event on the image display area 1201. When a touch-on event on the image display area 1201 is not acquired (S1101—NO), the process waits for acquisition of a touch-on event. When a touch-on event is acquired (S1101—YES), the process advances to step S1102.

In step S1102, the position determining unit 202 determines whether or not an operation control position (xOFF, yOFF) at the time of a touch-off on the operation screen is stored in the position storage unit 203. When an operation control position (xOFF, yOFF) at the time of a touch-off is not stored (S1102—NO), the process advances to step S1105. In step S1105, the position determining unit 202 sets the operation control position to a touch-on position (xON, yON).

On the other hand, when the position storage unit 203 stores an operation control position at the time of a touch-off (S1102—YES), the process advances to step S1103. In step S1103, the position determining unit 202 calculates a distance r between the operation control position (xOFF, yOFF) at the time of the touch-off and the touch-on position (xON, yON). The distance r can be calculated by r=[(xON−xOFF)²+(yON−yOFF)²]^{1/2}. Note that while (xON, yON) represents a touch position at the time of a touch-on, (xOFF, yOFF) represents an operation control position instead of a touch position at the time of a touch-off.

In step S1104, the position determining unit 202 determines whether or not the distance r is longer than a prescribed threshold α (distance r>threshold α). When the distance r is longer than the threshold α (distance r>threshold α), the process advances to step S1105 and the position determining unit 202 sets the operation control position to the touch-on position (xON, yON). On the other hand, when the distance r is equal to or shorter than the threshold α (distance r≤threshold α), the process advances to step S1106 and the position determining unit 202 sets the operation control position to the stored operation control position (xOFF, yOFF) at the time of the touch-off.

A magnitude of the threshold α may be a prescribed value set in advance or a value that is dynamically determined in accordance with a width of the operation control 1202 (when a size of the operation control 1202 is variable). For example, the threshold α can be set to approximately the same magnitude as (for example, around 1 to 1.5 times) a contact region between a finger and the touch panel when the user performs a touch operation. Alternatively, the threshold α can be set to around 1 to 10 times half the width of the knob 320. Alternatively, as the threshold α, a value selected based on a prescribed criterion from a plurality of values obtained as described above such as a minimum value or a maximum value among the plurality of values can be adopted.

In step S1107, a determination is made regarding whether or not the input acquiring unit 201 has acquired a touch-off event. A touch-off event not having been acquired means that an operation such as a drag is ongoing and the finger is not yet separated from the touch panel. When a drag operation is being performed, the position determining unit 202 determines an operation control position in accordance with a touch-on position (xON, yON) and a current touch position (x, y) (S1109). For example, the position determining unit 202 determines a position obtained by adding a movement amount (x−xON, y−yON) to the operation control position determined in step S1105 or S1106 as a new operation control position.

When a touch-off event has been acquired in step S1107, the process advances to step S1108 and an operation control position at the time of acquisition of the touch-off event is stored in the position storage unit 203. When an operation control position (xOFF, yOFF) is already stored in the position storage unit 203, the operation control position is overwritten and updated by a new value.

Moreover, when a vicinity of an operation control position at the time of a previous touch-off is touched at a timing where hardly any time has elapsed from the time of the previous touch-off, it is highly likely that the user desires to designate the same operation control position. On the other hand, when a long period of time has elapsed from the time of the previous touch-off, the likelihood of the user desiring to designate the same operation control position has conceivably decreased even if a vicinity of the operation control position at the time of the previous touch-off is touched on. In consideration thereof, in step S1108, the time of acquisition of the touch-off event is stored in the position storage unit 203 in association with an operation control position. In addition, in step S1102, when a current time point represents a lapse of a prescribed period of time or more from the time stored in association with an operation control position, a determination that an operation control position at the time of a touch-off is not stored (No in S1102) may be made. Alternatively, when a prescribed period of time elapses from the time stored in association with an operation control position, the time may be erased together with the operation control position from the position storage unit 203. With this configuration, the operation control position at the time of the previous touch-off is selectively used in accordance with not only a distance from the operation control position at the time of the previous touch-off but also in accordance with an elapsed time from the time of the previous touch-off. Therefore, an accurate operation control position that is in tune with the user's intention can be designated.

Although not clearly indicated in the flow chart described above, with an update of the operation control position, the UI display controlling unit 204 updates the display of the operation control 1202 shown in FIG. 12 and, at the same time, the process executing unit 205 performs prescribed processes. For example, in response to a touch-off operation, the process executing unit 205 executes a process based on a position corresponding to the touch-off operation. In addition, when a distance between a position corresponding to a touch-on operation and a position corresponding to a previous touch-off operation is shorter than a prescribed value, the process executing unit 205 executes a process based on a position corresponding to the previous touch-off operation. When the distance is longer than the prescribed value, in response to a touch-on operation, the process executing unit 205 executes a process based on a position corresponding to the touch-on operation. An example of the processes performed by the process executing unit 205 is a process of updating an image to be displayed in the image display area 1201. In addition, for example, when the operation control designates a position of a slider on a slider bar, the position of the slider is displayed so as to be moved in response to a position of the operation control. Furthermore, any of a plurality of frames included in a moving image may be selected based on a position of the operation control and an image displayed in the image display area 1202 may be updated. Alternatively, based on a position of the operation control, a parameter used to adjust the content possessed by the mobile device 100 may be designated. For example, based on the position of the operation control, a pixel included in an image to be displayed in the image display area 1201 may be designated and display characteristics such as a color temperature of the image to be displayed may be changed in accordance with the designated pixel. In addition, these processes are executed when the operation control position is updated in steps S1105, S1106, and S1109.

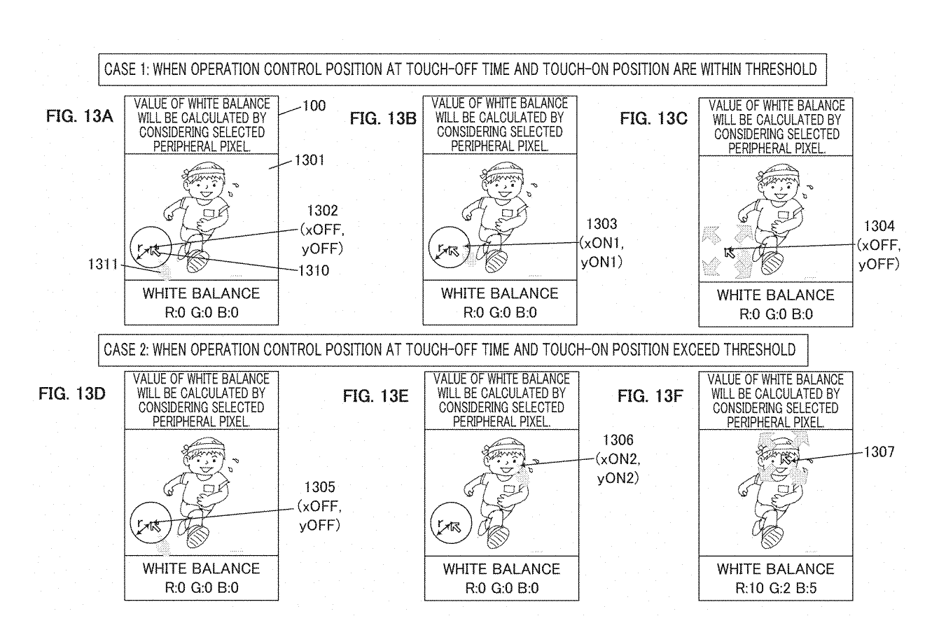

FIGS. 13A to 13F represent an example of a UI control operation according to an embodiment of the present invention. In the example shown in FIGS. 13A to 13F, a position of an operation control at the time of a touch-on is controlled in accordance with a distance between an operation control position at the time of a touch-off and the time of a touch-on in continuously photographed images.

First, a case where the distance between the operation control position at the time of a touch-off and a subsequent touch-on position is equal to or shorter than a threshold will be described with reference to FIGS. 13A to 13C. A display screen indicated by reference numeral 1301 is an image of an application installed on the mobile device 100 that is a smartphone, a tablet, or the like. The application has a function for calculating a white balance based on a selected pixel in a displayed image and applying the calculated white balance to the displayed image. A file format of images to be displayed is not particularly limited. For example, a JPEG file, a RAW file, and a moving image file may be displayed. In addition, images to be displayed may be those stored in the mobile device 100, or continuously photographed images stored in an imaging device may be transferred to the mobile device 100 to be displayed.

An operation control 1310 in FIG. 13A is an indicator which is moved upward, downward, leftward, and rightward on an image by an operation such as a drag in order to designate a pixel at a prescribed position. In the example shown in FIGS. 13A to 13F, a cursor is used as the operation control. In addition, reference numeral 1311 indicates a hand of the user operating the mobile device 100. Reference numeral 1302 indicates an operation control position (xOFF, yOFF) in a case where the user touches off the operation control. Reference numeral 1303 in FIG. 13B indicates a position (xON1, yON1) at which the user has touched on the terminal after the touch-off. In addition, the position determining unit 202 calculates a distance between the operation control position (xOFF, yOFF) in a case of a touch-off and the touch-on position (xON1, yON1). When the calculated distance does not exceed a threshold, as indicated by reference numeral 1304 in FIG. 13C, the operation control position is set to the operation control position (xOFF, yOFF) at the time of the touch-off.

Next, a case where the distance between the operation control position at the time of a touch-off and a touch-on position exceeds the threshold will be described with reference to FIGS. 13D to 13F. Reference numeral 1305 in FIG. 13D indicates an operation control position (xOFF, yOFF) in a case where the user touches off the operation control. Reference numeral 1306 indicates a position (xON2, yON2) at which the user has touched on the terminal after the touch-off. In addition, the position determining unit 202 calculates a distance between the operation control position (xOFF, yOFF) in a case of a touch-off and the touch-on position (xON2, yON2). When the calculated distance exceeds the threshold, a position of the operation control is set based on the touch-on position (xON2, yON2) as indicated by reference numeral 1307 in FIG. 13F. In this example, a white balance is calculated based on a pixel at a new touch position 1307 and the calculated white balance is applied to the displayed image shown in FIG. 13F.

### Eighth Embodiment

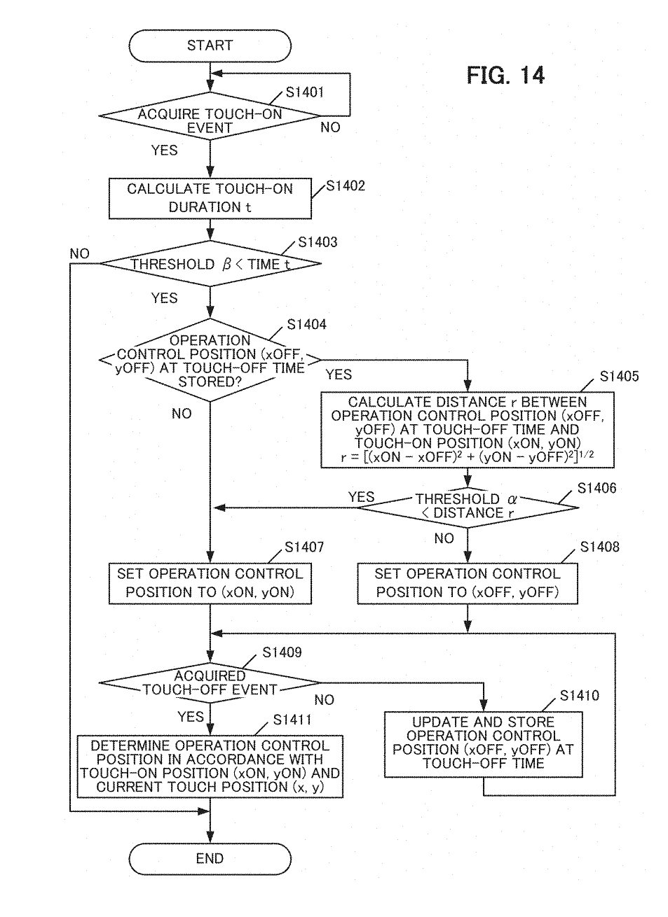

FIG. 14 is a flow chart showing a control procedure of an operation control according to an embodiment of the present invention. In the example of FIG. 14, movement of an operation control is also disabled when a distance between an operation control position at the time of a touch-off and the time of a touch-on exceeds a threshold. Hereinafter, respective steps of the flow chart shown in FIG. 14 will be described.

In step S1401, a determination is made regarding whether or not the input acquiring unit 201 has acquired a touch-on event on the image display area 1201. When a touch-on event on the image display area 1201 is not acquired (S1401—NO), the process waits for acquisition of a touch-on event. When a touch-on event is acquired (S1401—YES), the process advances to step S1402.

In step S1402, the input acquiring unit 201 calculates a touch-on duration t from the touch-on event and the process advances to step S1403. In step S1403, the input acquiring unit 201 compares the touch-on duration t with a prescribed threshold β and determines whether or not the touch-on duration t is longer than the threshold β. When the touch-on duration t is equal to or shorter than the threshold β (touch-on duration t≤threshold β), an operation of the position of the operation control is disabled and the process is terminated. Since it is highly likely that the user has touched the operation screen by mistake when the touch-on duration is short, this control produces an effect of preventing an unintentional movement of the operation control. When the touch-on duration t is longer than the threshold β (touch-on duration t>threshold β), it is determined that the user has intentionally touched on and the process advances to step S1404.

In step S1404, the position determining unit 202 determines whether or not an operation control position (xOFF, yOFF) at the time of a touch-off is stored in the position storage unit 203. When the position storage unit 203 does not store the operation control position (xOFF, yOFF) at the time of a touch-off in step S1407, a position of the operation control is set to a touch-on position (xON, yON). When the position storage unit 203 stores the operation control position at the time of a touch-off, in step S1405, the position determining unit 202 calculates a distance r between the operation control position (xOFF, yOFF) at the time of the touch-of and the touch-on position (xON, yON).

In step S1406, the position determining unit 202 determines whether or not the distance r is longer than a threshold α (distance r>threshold α). When the distance r is longer than the threshold α (distance r>threshold α), in step S1407, the position of the operation control is set to the touch-on position (xON, yON). When the distance r is equal to or shorter than the threshold α (distance r≤threshold α), in step S1408, the position of the operation control is set to the operation control position (xOFF, yOFF) at the time of the touch-off.

In step S1409, a determination is made regarding whether or not the input acquiring unit 201 has acquired a touch-off event. A touch-off event not having been acquired means that an operation such as a drag is ongoing and the finger is not yet separated from the touch panel. When a drag operation is being performed, the position determining unit 202 determines an operation control position in accordance with a touch-on position (xON, yON) and a current touch position (x, y) (S1410). For example, the position determining unit 202 determines a position obtained by adding a movement amount (x−xON, y−yON) to the operation control position determined in step S1407 or S1408 as a new operation control position.

When a touch-off event has been acquired in step S1409, the process advances to step S1411 and an operation control position at the time of acquisition of the touch-off event is stored in the position storage unit 203. When an operation control position (xOFF, yOFF) is already stored in the position storage unit 203, the operation control position is overwritten and updated by a new value.

### Ninth Embodiment

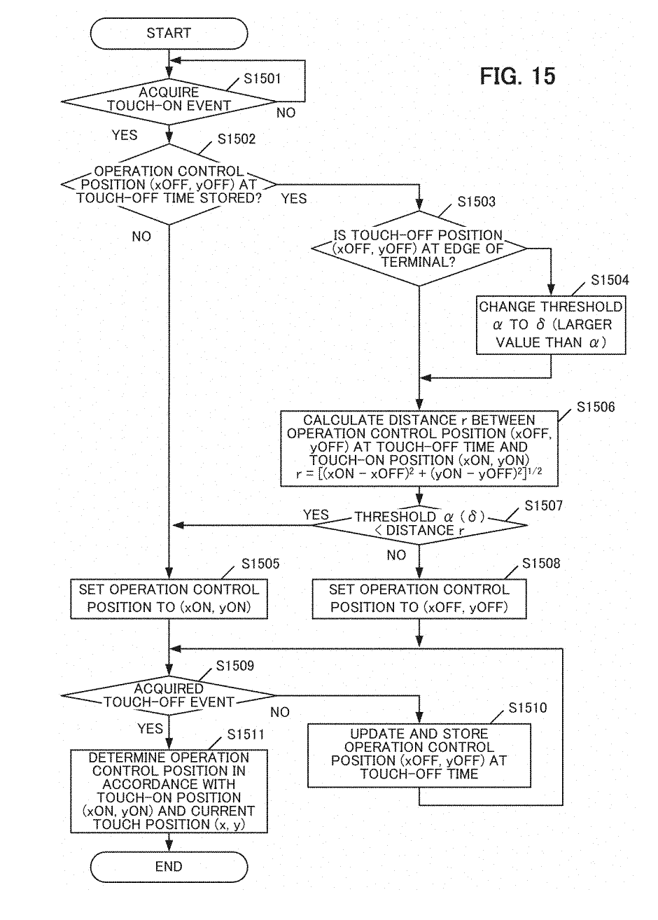

FIG. 15 is a flow chart showing a control procedure of an operation control according to an embodiment of the present invention, in the example shown in FIG. 15, when an operation control position at the time of a touch-off on the display screen is an edge of the screen, an operation control position when a touch-on is performed once again is set so as to enable an operation to be readily restarted from the operation control position at the time of the touch-off. Hereinafter, respective steps of the flow chart shown in FIG. 15 will be described.

In step S1501, a determination is made regarding whether or not the input acquiring unit 201 has acquired a touch-on event. When a touch-on event on the image display area 1201 is not acquired (S1501−NO), the process waits for acquisition of a touch-on event. When a touch-on event on the image display area 1201 is not acquired, the process advances to step S1502.

In step S1502, the position determining unit 202 determines whether or not an operation control position (xOFF, yOFF) at the time of a touch-off is stored in the position storage unit 203. When an operation control position at the time of a touch-off is not stored (S1502—NO), the process advances to step S1505. In step S1505, the position determining unit 202 sets the operation control position to a touch-on position (xON, yON).

On the other hand, when the position storage unit 203 stores the operation control position at the time of a touch-off, in step S1503, the input acquiring unit 201 determines whether or not the touch-off position (xOFF, yOFF) is an edge of the terminal. As will be described later, the operation control is displayed so as not to overlap a touching finger. This measure is taken in order to prevent the operation control from being hidden by a finger of the user and to allow the user to recognize a location being indicated by the finger. For example, when performing a touch operation by a finger on the right hand, the operation control is positioned above and to the left of a position indicated by the finger and displayed so as not to overlap the finger. In addition, the edge of the terminal as described in step S1503 refers to a right edge and a bottom edge of the screen. When the finger is moved to the right edge and the bottom edge of the screen in a state where the operation control is displayed above and to the left of the position indicated by the finger, the finger moves outside of the screen (outside of a region of the touch sensor) before the operation control does. In this state, the operation control can no longer be operated. In consideration thereof, a magnitude of the threshold is changed in order to enable the operation control to readily move to the right edge and the bottom edge of the screen when a touch-on is performed once again. When the touch-off position (xOFF, yOFF) is an edge of the terminal (S1503—YES), the threshold α is changed to δ (a larger value than α) in step S1504 and the process advances to step S1506.

In step S1506, the position determining unit 202 calculates a distance r between the operation control position (xOFF, yOFF) at the time of the touch-off and the touch-on position (xON, yON). In step S1507, the position determining unit 202 determines whether or not the distance r is longer than a prescribed threshold α (or δ) (distance r>threshold α (δ)). When the distance r is longer than the threshold α (δ) (distance r>threshold α (δ)), the process advances to step S1505 and the position determining unit 202 sets the operation control position to the touch-on position (xON, yON). On the other hand, when the distance r is equal to or shorter than the threshold α (δ) (distance r≤threshold α (δ)), the process advances to step S1508 and the operation control position is set to the operation control position (xOFF, yOFF) at the time of the touch-off.

In step S1509, a determination is made regarding whether or not the input acquiring unit 201 has acquired a touch-off event. A touch-off event not having been acquired means that an operation such as a drag is ongoing and the finger is not yet separated from the touch panel. When a drag operation is being performed, the position determining unit 202 determines an operation control position in accordance with a touch-on position (xON, yON) and a current touch position (x, y) (S1510). When a touch-off event has been acquired, the process advances to step S1511 and an operation control position at the time of acquisition of the touch-off event is stored in the position storage unit 203. When an operation control position (xOFF, yOFF) is already stored in the position storage unit 203, the operation control position is overwritten and updated by a new value.

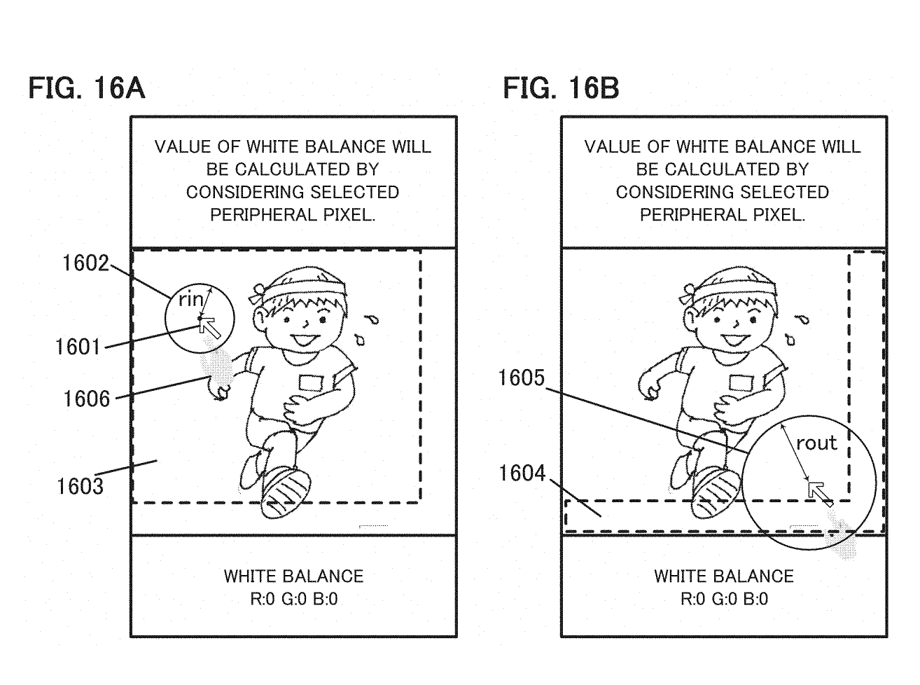

FIGS. 16A and 16B represent an example of an operation screen according to an embodiment of the present invention. In the example shown in FIGS. 16A and 16B, when a touch position at the time of a touch-on is an edge of the screen, control is realized so as to increase a threshold and enable an operation to be readily restarted from the operation control position at the time of the touch-off. An operation control 1601 is an indicator which is moved upward, downward, leftward, and rightward on the operation screen by an operation such as a drag in order to designate a pixel at a prescribed position and, in the present embodiment, an arrow cursor is used as the operation control 1601. In the example shown in FIG. 16A, the operation control 1601 is displayed so as not to overlap a touching finger 1606. This measure is taken in order to allow the user to recognize a location being indicated. In the example shown in FIGS. 16A and 16B, the operation screen is touched by a finger on the right hand, and the operation control is displayed above and to the left of a position indicated by the finger so as not to overlap the finger.

Reference numeral 1602 indicates a threshold for determining which position a movement of the operation control is to be started from when a touch-on is performed once again, and the threshold is set with respect to a distance from an operation control position at the time of a touch-off. In FIG. 16A, the threshold 1602 is depicted by a circle of which a radius is a threshold rin and a center is the operation control position 1601 at the time of the touch-off. When a touch-on is performed within a region of the threshold 1602, a movement of the operation control is started from the operation control position at the time of the touch-off.

In addition, a value of the threshold 1602 may be changed depending on a position where a touch-on event on the operation screen is acquired. For example, in the present embodiment, when a touch-on event is acquired inside a region indicated by reference numeral 1603, the threshold is assumed to be rin. When the operation control is displayed above and to the left of a finger on the right hand, in the region 1603, the operation control can be moved by one operation by maintaining touch-on.

On the other hand, when attempting to select a region indicated by reference numeral 1604 in FIG. 16B using the operation control, the finger moves outside of the screen before the operation control does. Therefore, after performing a touch-on once again and enabling a movement of the operation control from a previous touch-off position, the operation control must be moved to lower right and to a bottom edge of the screen. In order to facilitate this operation, when the touch-off position is inside the region 1604, a threshold rout indicated by reference numeral 1605 is changed to a value greater than the threshold rin indicated by reference numeral 1602. Accordingly, when a touch-on is performed once again, an operation control position is more readily set to the previous touch-off position. While an example has been described in which, when a touch-on is performed by a finger on the right hand, the operation control is displayed above and to the left of the finger, it is needless to say that, when a touch-on is performed by a finger on the left hand, the operation control is displayed above and to the right of the finger and the region 1604 is changed to a left edge and a bottom edge. Means for switching display of the operation control between above left and above right will be described later.

### Tenth Embodiment

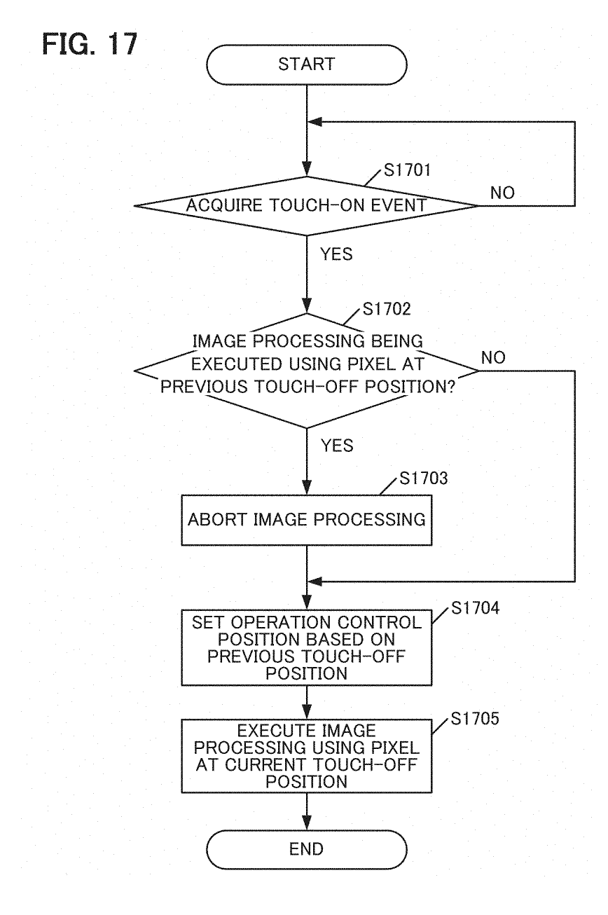

FIG. 17 is a flow chart showing a procedure of image processing according to an embodiment of the present invention. In the present embodiment, it is assumed that image processing is executed based on a pixel selected at the time of a touch-off. In the example shown in FIG. 17, when a touch-on is performed after touching off the operation control during the execution of image processing, the image processing is aborted and image processing is executed based on a new touch-off position. In step S1701, a determination is made regarding whether or not the input acquiring unit 201 has acquired a touch-on event. When a touch-on event is not acquired (S1701—NO), the process waits for acquisition of a touch-on event.

In step S1702, a determination is made regarding whether or not image processing is being executed by the process executing unit 205 using a pixel at a previous touch-off position. When a process based on the previous touch-off position is being executed (S1702—YES), the process advances to step S1703. When a process based on the previous touch-off position is not being executed (S1702—NO), the process advances to step S1704. In step S1703, image processing is aborted and the process advances to step S1704.

In step S1704, the position determining unit 202 determines a start position of the operation control based on the previous touch-off position. Since a description of this process has already given, a description will be omitted here. In step S1705, image processing is executed using a pixel at a current touch-off position. In the present embodiment, while image processing using a pixel at the previous touch-off position is aborted before the process of step S1704, alternatively, the image processing may be aborted only when a position of the operation control changes as a result of the process of step S1704.

### Eleventh Embodiment

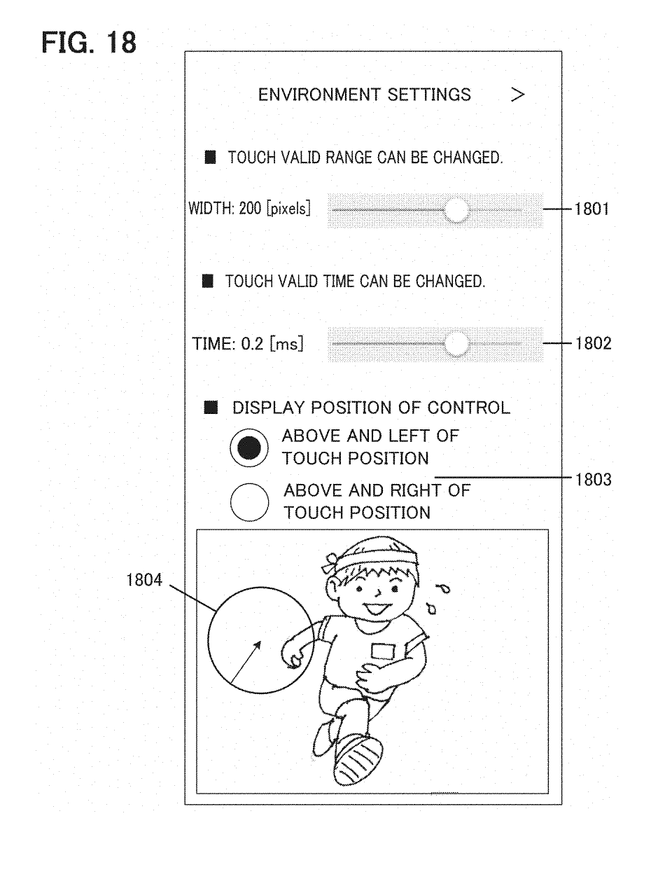

FIG. 18 shows an example of a setting screen for setting a touch valid range and a touch valid time as well as a display position of an operation control according to an embodiment of the present invention. Reference numeral 1801 indicates a slider control for changing a touch valid range. In this case, when a value thereof is changed, a circle 1804 indicating a valid range displayed at the bottom of the screen is displayed in a changed size. Reference numeral 1802 indicates a slider control for changing a touch valid time. The valid time is used as a threshold for preventing the seek bar or the operation control from moving when erroneously touched. Reference numeral 1803 indicates a tab for switching between setting a display position of the operation control to above and setting the display position to the left of a touch position or to above and to the right of the touch position. At which position the operation control is to be displayed can be selected in accordance with a dominant hand of the user (right-dominant or left-dominant). In addition, this setting is also used to switch among settings of regions corresponding to the thresholds rin and rout described with reference to FIGS. 16A and 16B. In this manner, control of operations of the operation control can be customized in accordance with a selection made by the user.

### Other Embodiments

Examples of operations for designating one display or playback position of continuously-photographed images, a moving image, or audio using a seek bar UI have been described above. However, a seek bar UI can be used to designate a range by designating two positions, namely, a start point and an end point. The present invention is also applicable to cases where a seek bar UI is used to designate such a plurality of positions.

While a seek bar UI has been described above as an example, user interfaces of which a slide operation can be performed in a similar manner to a seek bar UI include a scroll bar and a slider control. The present invention is similarly applicable to such user interfaces of which a slide operation can be performed. In addition, the present invention can be applied not only to performing a slide operation (a movement in one direction) but also to designating a position of a user interface element (UI element) of which a movement operation can be performed in any direction.

While control is performed based on a distance between a position of a UI element at the time of a touch-off and a touch-on position in the description given above, control need not necessarily be performed based on a distance between two points. For example, a drawing region of a UI element at the time of a touch-off may be stored, and when the inside of a prescribed region including the drawing region and a peripheral region thereof is touched on, it can be assumed that the position of the UI element at the time of the touch-off has been touched on. A shape of the prescribed region (the peripheral region) may be any shape. For example, the prescribed region can be set to a region in which a shortest distance to the UI element is equal to or shorter than a prescribed distance. Moreover, in the first embodiment, a position of a UI element is represented by a point and a prescribed region is defined as a region within a prescribed distance from the position. These prescribed distances (thresholds) may be set in advance or may be settable by the user as in the sixth embodiment.

According to the present invention, usability of a user interface which enables a position to be designated in response to a user operation is improved and a user can readily designate a desired position.

While the present invention is applied to a mobile device in the description given above, an application destination of the present invention is not limited thereto. For example, the present invention can be applied to any information-processing device such as a personal computer (PC), a digital still camera, and a digital video camera.

In addition, an embodiment in which a position of an operation control is determined using a touch-on duration as in the third embodiment may be applied to the seventh to eleventh embodiments.

The present invention can also be achieved by supplying a program that realizes one or more functions of the embodiments described above to a system or a device via a network or a storage medium and having one or more processors in a computer in the system or the device read and execute the program. Alternatively, the present invention can also be achieved by a circuit (for example, an ASIC) which realizes one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

What is claimed is:

1. An information-processing device, comprising:
display controlling unit configured to cause a display device to display a movable user interface element (UI element);
detecting unit configured to detect a user operation on the display device;
acquiring unit configured to acquire a first position at which the user operation is detected on the display device;
determining unit configured to determine a second position at which the UI element is displayed on the display device, based on the acquired first position;
storing unit configured to store the second position at the time of termination of detection of the user operation by the detecting unit; and
calculating unit configured to calculate a distance between a third position when detection of a user operation is newly started and the second position stored in the storing unit;
wherein when detection of the user operation is newly started, the display controlling unit controls the UI element to be selectively displayed at any one of a fourth position determined based on the third position and the second position stored in the storing unit, in accordance with the calculated distance.

2. The information-processing device according to claim 1, wherein when a drag operation is continuously detected after detection of the user operation is started by the detecting unit, the display controlling unit causes the UI element to be displayed in a position which is moved from the position selected in accordance with the calculated distance, in accordance with the drag operation.

3. The information-processing device according to claim 1, wherein when a duration of the user operation is shorter than a threshold, the display controlling unit causes the UI element to he displayed without changing a position at which the UI element is displayed on the display device.

4. The information-processing device according to claim 1, wherein when a duration of the user operation is longer than a threshold, the display controlling unit causes the UI element to be displayed at the fourth position regardless of the calculated distance.

5. The information-processing device according to claims 1, wherein the storing unit stores a plurality of previous second positions, and the calculated distance is based on the third position and the plurality of second positions.

6. The information-processing device according to claim 5, wherein the calculated distance is based on a position selected among the plurality of second positions based on a time at which the UI element had been displayed.

7. The information-processing device according to claim 5, wherein the calculated distance is based on a position selected by a user among the plurality of second positions.

8. The information-processing device according to claim 1, wherein a slide operation of the UI element can be performed in a prescribed direction in an operating region displayed on the display device, and the UI element indicates a playback location of content displayed on the display device.

9. The information-processing device according to claim 8, wherein the content includes at least one of continuously-photographed images, a moving image, a plurality of still images, and audio.

10. The information-processing device according to claim 8, wherein the display controlling unit causes content corresponding to the second position or the fourth position of the UI element to be displayed on the display device.

11. The information-processing device according to claim 1, wherein the UI element can be moved on an image displayed on the display device and is used to designate a pixel of the image.

12. The information-processing device according to claim 1, wherein the UI element can be moved in an operating region displayed on the display device and indicates an adjustment value of content.

13. The information-processing device according to claim 1,
wherein the storing unit is further configured to store a time when detection of the user operation is terminated, in association with the second position, and
wherein the display controlling unit is configured to perform control so that the UI element is displayed at a selected position in accordance with an elapsed time from the time when detection of the user operation is terminated.

14. An information-processing device, comprising:
detecting unit configured to detect a touch operation on a display device;
first processing unit configured to execute, in response to a first touch operation on the display device, a process based on a first position corresponding to the first touch operation;
storing unit configured to store the first position used for the execution of the process;
calculating unit configured to calculate, when a second touch operation on the display device is detected, a distance between the stored first position and a second position corresponding to the second touch operation; and
second processing unit configured to execute a process based on the first position in response to the second touch operation when the distance is shorter than a prescribed value but executing a process based on the second position in response to the second touch operation when the distance is longer than the prescribed value.

15. The information-processing device according to claim 14, wherein the process is a process of displaying a slider on a slider bar based on the position.

16. The information-processing device according to claim 14, wherein the process is a process of selecting any of a plurality of frames included in a moving image based on the position.

17. The information-processing device according to claim 14,
wherein an image is displayed on the display device, and
wherein the process is a process of designating a pixel included in the image based on the position.

18. The information-processing device according to claim 14,
wherein an operating region is displayed on the display device, and
wherein the process is a process of designating a parameter used to adjust content based on e position.

19. The information-processing device according to claim 14, wherein when a duration of the second touch operation is longer than a prescribed value, the processing unit executes a process based on the second position in response to the second touch operation regardless of the calculated distance.

20. The information-processing device according to claim 14,
wherein the storing unit further stores a time at which the first position had been acquired, in association with the first position used for the execution of the process, and
wherein when an elapsed time from the stored time to an acquisition of the second position is longer than a prescribed value, the processing unit executes a process based on the second position in response to the second touch operation regardless of the calculated distance.

21. A non-transitory computer-readable storage medium storing a program which causes a computer to function as the respective unit of the information-processing device according to claim 1.

22. A non-transitory computer-readable storage medium storing a program which causes a computer to function as the respective unit of the information-processing device according to claim 14.
